(19) United States
(12) Patent Application Publication
(10) Pub. No.: US 2018/0191702 A1
(43) Pub. Date: Jul. 5, 2018

(54) MULTIPLE FIELD AUTHENTICATION

(71) Applicant: CA, Inc., New York, NY (US)

(72) Inventors: Ragavendran Padmanabhan, Hyderabad (IN); Shaik Mokhinuddeen, Hyderabad (IN); Koti Reddy Aluri, Hyderabad (IN)

(21) Appl. No.: 15/397,398

(22) Filed: Jan. 3, 2017

(51) Int. Cl. H04L 29/06

(52) U.S. Cl. CPC H04L 63/083; H04L 63/10

(57) ABSTRACT

Techniques are disclosed relating to authenticating a user via a login screen. In one embodiment, a computer system displays a login screen having an arrangement of input fields where each input field is operable to receive a character. In some embodiments, the computer system receives a request from a user to access the computer system. The request may include a first passcode having characters input into a first subset of the input fields. The computer system then verifies the first passcode against a second passcode of an authorized user. The verifying may include comparing characters of the first passcode with characters of the second passcode and determining whether the first subset of input fields matches a second subset of the input fields used by the authorized user to input characters. Based on the verifying, the computer system may provide the user with access to the computer system.

### BACKGROUND

### Technical Field

This disclosure relates generally to computing devices, and, more specifically, to user authentication.

### Description of the Related Art

Traditional authentication measures typically rely on a user to provide a password, which may include alphabet letters, numbers, and/or special characters, in order to authenticate. A factor in the strength of a password is the number of possible permutations (or guesses) required to obtain the actual password. For example, a four-character password using only lower-case alphabet letters has 456,976 (i.e. 26⁴) possible permutations. If an intruder is attempting a brute force attack, the intruder may have to attempt that many permutations in a worst case scenario to guess the password. Accordingly, longer passwords can potentially provide greater strength as they allow for more possible permutations.

### SUMMARY

The present disclosure describes embodiments in which a user is presented with a login screen that allows the user to authenticate. In one embodiment, the login screen depicts an arrangement of input fields where each input field is operable to receive one or more characters of a password. In such an embodiment, the user inputs characters of the password into a subset of the input fields. The user may then be authenticated by comparing the supplied characters with a stored password of an authorized user and determining that the subset of input fields corresponds to those used to enter the stored password. In some embodiments, the login screen is presented to authenticate a user attempting to access a device such that the device provides the user with access to the device upon authenticating the user. In other embodiments, authentication may be performed for other purposes.

### BRIEF DESCRIPTION OF THE DRAWINGS

FIG. 1 is a block diagram illustrating an exemplary login screen, according to some embodiments.

FIG. 2A is a block diagram illustrating an exemplary a user device, according to some embodiments.

FIG. 2B is a block diagram illustrating an exemplary interaction between a user device and a server, according to some embodiments.

FIG. 3 is a block diagram illustrating an exemplary memory unit that includes a handler for comparing passwords, according to some embodiments.

FIG. 4 is a flow diagram illustrating an exemplary method for authenticating a user, according to some embodiments.

This disclosure includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “network interface configured to communicate over a network” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. Thus, the “configured to” construct is not used herein to refer to a software entity such as an application programming interface (API).

The term “configured to” is not intended to mean “configurable to.” An unprogrammed FPGA, for example, would not be considered to be “configured to” perform some specific function, although it may be “configurable to” perform that function and may be “configured to” perform the function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the terms “first,” “second,” etc. are used as labels for nouns that they precede, and do not imply any type of ordering (e.g., spatial, temporal, logical, etc.) unless specifically stated. For example, in a password that has multiple portions, the terms “first” and “second” portions can be used to refer to any portion of a password. In other words, the “first” and “second” portions are not limited to the initial two portions of a password.

As used herein, the term “based on” is used to describe one or more factors that affect a determination. This term does not foreclose the possibility that additional factors may affect a determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is thus synonymous with the phrase “based at least in part on.”

### DETAILED DESCRIPTION

Encouraging people to use longer passwords can be difficult. A user may need to remember multiple passwords for accessing different websites, and opt to use shorter passwords as they are easy to remember. If a user does elect to use a longer password, that user may use the same password for multiple accounts, which poses a security vulnerability if one of the accounts becomes compromised. Still further, some administrators may require users to periodically change passwords placing additional burden on a user to remember everything correctly.

The present disclosure describes techniques for increasing the strength of a password without increasing its length. As will be described below in various embodiments, a user is presented with a login screen having multiple input fields. (As used herein, the term “login screen” refers to any suitable interface usable to receive a user-supplied credential for authenticating a user to access some resource such as a computing device, application, website, database, etc.) Rather than input a password into a single field or all fields, the user selects a subset of the fields for entering portions of the password. (As used herein, the terms “password” and “passcode” refer generally to any user-supplied credential for authenticating a user.) The entered characters are then combined with the particular selected subset of fields to form what is used to authenticate the user. By using the selected subset of fields as an additional factor, the number of potential permutations is increased strengthening the password. In doing so, it may be possible to obtain the same password strength for a shorter password entered into multiple fields as a longer password entered into a single field.

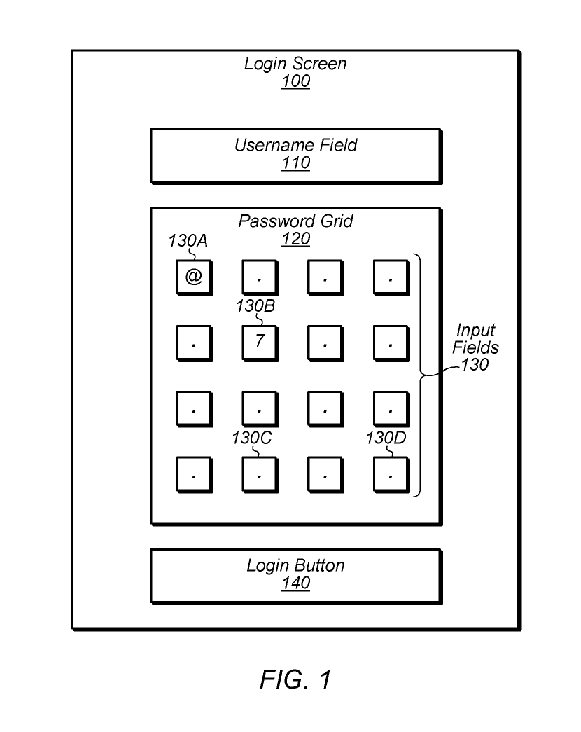

Turning now to FIG. 1, a block diagram of a login screen 100 is depicted. In some embodiments, login screen 100 may be presented as a screen for authenticating a user attempting to access a computing device—e.g., unlocking a desktop computer. In other embodiments, however, login screen 100 may be presented to authenticate a user for various other purposes such as accessing content of an application executing on the device presenting screen 100, accessing an external service such as a website hosted by a separate web server, etc. In the illustrated embodiment, login screen 100 includes a username field 110, a password matrix/grid 120 that includes input fields 130, and a login button 140. In some embodiments, login screen 100 may be implemented differently than shown. For example, in some embodiments, username field 110 or login button 140 may not be present (or presented on separate screens). In some embodiments, more (or less) input fields 130 may be depicted; grid 120 may also have a shape other than a square such as triangle, rectangle, etc.

Input fields 130, in one embodiment, are fields configured to receive one or more characters from a user. Accordingly, when a user account is initially created, the user may be asked to create a password by entering characters into a subset of input fields 130. For example, as shown, the user may enter a single character into each of fields 130A-D. The combination of characters and input fields 130 serves as the user's password and is stored in memory in order to verify subsequent access requests. In various embodiments, password grid 120 may associate the characters placed in input fields 130 with field identifiers corresponding to those input fields 130. For example, in one embodiment, fields 130 may be enumerated as 1-16 such that the symbol @ placed in input field 130A may be associated with an identification number of 1. In another embodiment, fields 130 may be identified using coordinates based on their respective positions in grid 120—e.g., the symbol @ may be associated with the coordinate (1, 1) representative of the row and column in grid 120 in which field 130A resides.

In various embodiments, when the user wishes to authenticate, the user supplies the correct characters to the correct input fields; otherwise, the system rejects the attempt by the user. For example, an authorized user may have entered the password “@7ZQ” into fields 130A-D, respectively. If a nefarious actor does not enter the correct character sequence (e.g., enters the number 8 for the letter Z), the system rejects the authentication attempt. Also, if the nefarious actor selects the wrong subset of fields (e.g., a subset set other than 130A-130D) or enters the sequence in the wrong ordering (e.g., Z is entered into field 130D), the system rejects the authentication attempt.

In some embodiments, additional factors may be considered when authenticating a user. For example, in the illustrated embodiment, screen 100 includes a field 110 for a user to input a username. As such, a user may be required to not only supply his or her correct password into fields 130, but also supply the correct username associated with that password. This username may also be used to determine which user account is to be accessed upon successful authentication. Once a user has provided all the appropriate credential information (e.g., the username and password), login button 140 may be selected by the user to indicate that the user has completed inputting the information and to cause verification of that information.

As credential information is provided, in some embodiments, input fields 130 and/or username field 110 may be configured to conceal characters input into them by the user. The concealment may include displaying an indication, such as a dot or an asterisk in place of the character to protect against others seeing the character and its corresponding location. For example, a user may input “7” into input field 130B and after a set period of time, input field 130B may display an indication similar to input field 130C as shown. Furthermore, login screen 100 may determine when a user is done suppling characters to input fields 130 based on a user action—e.g., a user hitting the ENTER key or pushing login button 140.

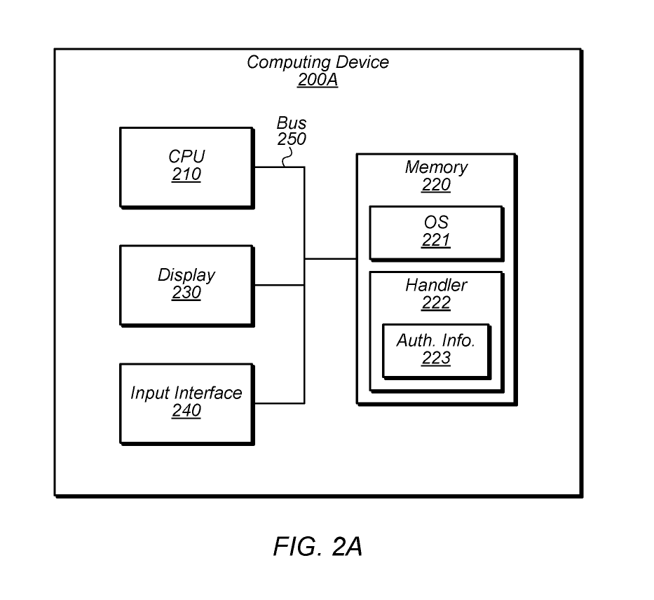

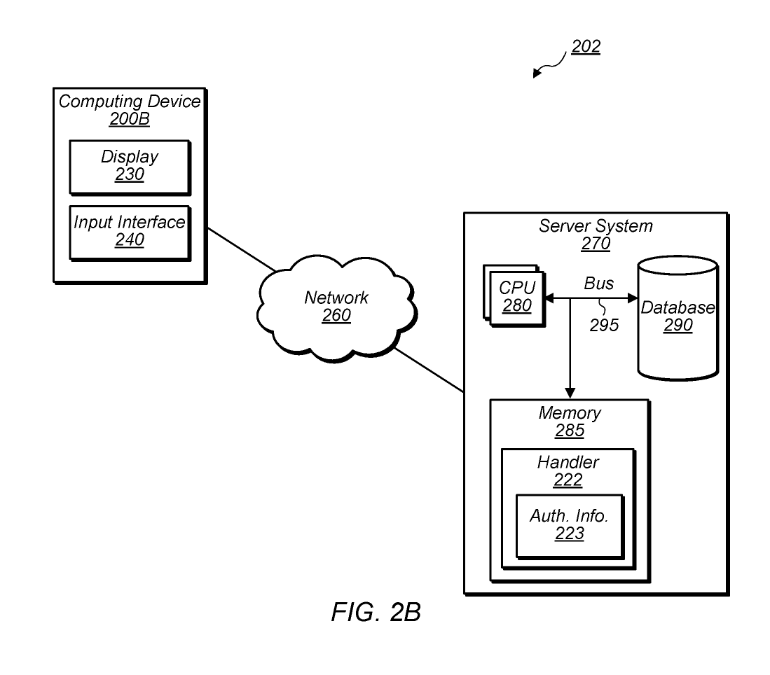

Turning now to FIG. 2A, a block diagram of a computing device 200A configured to present a login screen 100 and authenticate a user is depicted. Computing device 200A may be any suitable form of computing device such as a mobile device, a desktop computer, a laptop, etc. In the illustrated embodiment, the computing device 200A includes a central processing unit (CPU) 210, a memory 220, a display 230, and an input interface 240 connected together via a bus 250. Memory 220 includes an operating system (OS) 221 and a handler 222. Handler 222 includes authentication information 223. In some embodiments, computing device 200A is implemented differently than shown.

CPU 210, in one embodiment, is a processing unit configured to execute program instructions stored in a non-transitory computer readable medium such as memory 220 in order to implement functionality described herein. CPU 210 may include multiple processor cores, which may each be multi-threaded. In some embodiments, CPU 210 is configured to perform techniques to improve efficiency such as super-threading, hyper-threading, virtualization, and the like. Furthermore, CPU 210 may include specialized hardware for encrypting and decrypting files using AES encryption (or any known form of encryption/decryption). In various embodiments, CPU 210 uses a cache hierarchy that includes an L1 cache and an L2 cache.

Memory 220, in one embodiment, is a non-transitory computer readable medium configured to store program instructions executable to implement functionality described herein such as program instructions for OS 221 and/or handler 222. Memory 220 may be implemented using any suitable form of physical memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on.

OS 221 in one embodiment, is an operating system executable to manage various aspects of computing device 200A including controlling access to device 200A. In various embodiments, handler 222 interfaces with OS 221 (or is even a part of OS 221) in order to facilitate authenticating a user requesting access to device 200A. Accordingly, in response to receiving an indication that a user desires to access device 200A, handler 222 may generate a login screen 100 and request that OS 221 cause display 230 to present the login screen 100 to the user. OS 221 may collect information from interface 240 about input fields 130 (and the characters placed in them) and present this information to handler 222 to authenticate a user. Handler 222 may then instruct OS 221 to unlock a device 200A in response to a successful authentication.

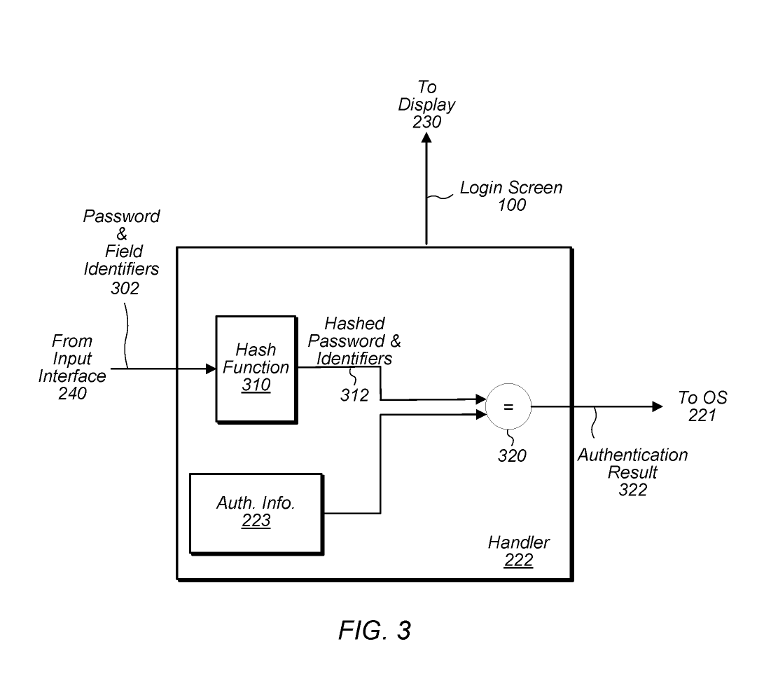

Handler 222, in one embodiment, is a set of program instructions executable to implement functionality described herein with respect to login screen 100. Accordingly, as will be described in greater detail below with respect to FIG. 3, handler 222 may be executable to present a login screen 100 and authenticate a user based on the user's input into interface 240. In various embodiments, handler 222 maintains authentication information 223 in order to perform user authentications. In some embodiments, the authentication information 223 may include a hash value calculated from the characters entered into input fields 130 as well as information identifying which fields received the characters.

Display 230, in one embodiment, is an interface configured to present content to a user such as login screen 100. Display 230 may be any suitable form of display such as a liquid crystal display (LCD), a light-emitting diode display (LED), a plasma display panel (PDP), or the like. In some embodiments, display 230 is a touch-sensitive display configured to implement functionality of input interface 240.

Input interface 240, in one embodiment, is configured to receive user inputs including authentication information input with fields 110, 130, and or 140. Although examples have been given with regards to a touch-sensitive display, input interface 240 may be any suitable form of interface such as a mouse, keyboard, joystick, stylus, camera, etc. For example, instead of typing the characters using a keyboard, a user may enter characters by selecting them from a pull down menu using a mouse button.

Turning now to FIG. 2B, a block diagram of a computer system 202 in which a client presents a lock screen for a server handling authentication is depicted. In the illustrated embodiment, system 202 includes a client computing device 200B and a server system 270, which communicate over a network 260. As shown, computing device 200B includes a display 230 and an input interface 240. Server system 270, in turn, includes a CPU 280, a memory 285 including handler 222, and database 290 coupled together via a bus 295. In some embodiments, system 270 may be implemented differently than shown.

As discussed above with respect to computing device 200A, in one embodiment, computing device 200B is configured to present a login screen 100 via display 230 and collect information authentication information input fields 110, 130, and/or 140 via input interface 240. Rather than perform authentication, however, computing device 200B, in the illustrated embodiments, communicates the collected authentication information over network 260 to server system 270, which may perform authentication via handler 222. Computing device 200B may correspond to any suitable computing device such as those listed above with respect to computing device 200A.

Network 260 may be any suitable form of computer network, which allows a computing device 200B and a server system 270 to exchange data. Accordingly, network 260 may include a combination of wired and wireless technologies that include optical fiber, Ethernet, cellular, radio, and the like. Network 260 may be implemented through bridges, repeaters, switches, routers, modems, and firewalls. Network 260 may be a local area network, wide area network, enterprise private network, virtual private network, and/or the like.

Server system 270, in one embodiment, is configured to authenticate a user of computing device 200B in order to facilitate performance of various operations. In some embodiments, this may include providing access to one or more services responsive to a successful authentication via a login screen 100. For example, server system 270 may use database 290 to implement a database server, a file server, a mail server, a print server, a web server, a game server, and/or an application server. Responsive to a successful authentication via screen 100, server system 270 may grant access to these services. In some embodiments, these services may be accessible to an application executing on computing device 200B. For example, a banking application executing on computing device 200B may retrieve an account balance stored in database 290 in response to a successful authentication of a user. In other embodiments, these services may be accessible to an application executing on server system 270. For example, a user may log into a banking website via a browser executing on computing device 200B, and server system 270 may present an account balance stored in database 290 in response to a successful authentication of a user. In some embodiments, functionality provided by server system 270 may be provided as part of a software as a service (SaaS). For example, in some embodiments, server system 270 may deliver an application to computing devices 200B that uses an authentication service provided by server system 270. In some embodiments, system 270 may provide access to content, such as virtual machine executing on server system 270. In the illustrated embodiment, server system 270 implements this functionality by executing handler 222 on CPU 280.

Turning now to FIG. 3, a block diagram of handler 222 is depicted. As noted above, in various embodiments, handler 222 is responsible for presenting a login screen 100 and/or authenticating a user. In the illustrated embodiment, handler 222 authenticates a user by performing a hash value comparison using a hash function 310 and a comparator 320.

As shown, this comparison process may begin with handler 222 receiving information 302 identifying an entered password and the fields 130 where the characters of the password were entered. In some embodiments, this information 302 is received as a string produced by concatenating the password with the corresponding identifiers. For example, entering the password “@7ZQ” into fields 130A-D might produce the sting “@11722Z42Q44,” where 11, 22, 42, and 44 are rows and columns for fields 130A-D shown in FIG. 1. Once information 302 has been received, this information 302 may be fed into hash function 310 in order to produce a corresponding hash value shown as hashed password & identifiers 312. Hash function 310 may be any suitable hashing algorithms such as any member of the secure hash algorithm family, the BLAKE2 algorithm, the MD5 algorithm, etc.

After the hash value 312 has been determined, handler 222 may perform a comparison 320 of this value 312 against authentication information 223. As noted, in some embodiments, authentication information 223 is a previously stored hash value corresponding to a password entered into a subset of fields 130 by an authorized user. If newly generated hash value 312 matches the previously stored one corresponding to authentication information 223, comparator 320 may provide an authentication result 322 indicating that a user has been successfully authenticated. If a match does not occur because the wrong characters were entered or the wrong input fields 130 were used, a result 322 may be provided indicating that the authentication has failed. In the illustrated, result 322 is shown as being provided to OS 221, which, in some embodiments, may use the result to determine whether to grant access to device 200A. In other embodiments in which an authentication is being performed for some other purpose, handler 222 may provide a result 322 to an entity other than OS 221.

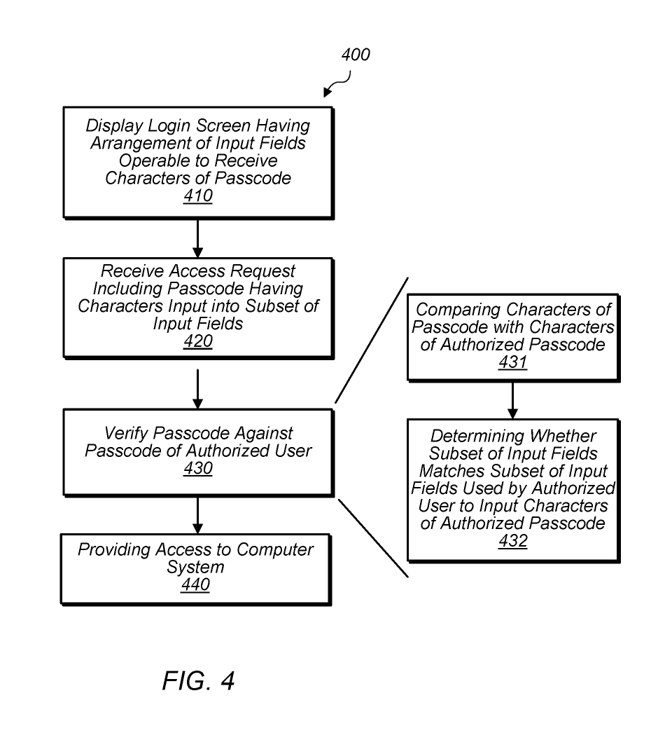

Turning now to FIG. 4, a flow diagram of a method 400 is depicted. Method 400 is one embodiment of a method performed by a computer system (e.g., device 200A, server system 270, etc.) to authenticate a user. In many instances, the performance of method 400 may allow user to authenticate using a shorter, yet equally secure passcode. In some embodiments, method 400 may include more (or less steps) than shown; steps may also be performed in a different order or concurrently.

Method 400 begins in step 410 with displaying a login screen (e.g., screen 100) having an arrangement of input fields (e.g., fields 130), each input field operable to receive a character of a passcode. In various embodiments, these input fields may receive and conceal characters of a passcode provide by a user. Such a concealment may include replacing the visual representation of the character with another character (e.g., an asterisk, a dot, etc.). In some embodiments, the input fields are arranged in a two-dimensional grid (e.g., grid 120) in which each position of the grid may correspond to an identifier. In some embodiments, the inputs fields may be arranged in a different pattern such a triangle, a circle, etc.

In step 420, the computer system receives a request from a user to access a computer system. In various embodiments, this request includes a first passcode having characters input into a subset of the input fields. In some embodiments, a user may also provide additional information usable to identify himself/herself to the computer system such as a username.

In step 430, the computer system verifies the first passcode against a second passcode of an authorized user. In various embodiments, this second passcode may be retrieved from a storage unit such as authentication information 223. Such a passcode may have been provide by the authorized user during a registration process, when updating a previous passcode, and so on. In various embodiments, step 430 includes substep 431 in which characters of the first passcode are compared with characters of the second passcode, and substep 432 in which a determination is made whether the first subset of input fields matches a second subset of input fields used by an authorized user to input the characters of the second passcode. In some embodiments, performance of steps 431 and 432 includes calculating a first hash value (e.g., value 312) for the first passcode based on the characters of the first passcode and identifiers of the first subset of input fields, and comparing the first hash value with a second hash value (e.g., in authentication information 223) calculated for the second passcode. In one embodiment, calculating the first hash value includes creating a string by concatenating characters of the first passcode with the identifiers of the first subset of input fields and applying a hash function to the string.

In step 440, the computer system provides the user access to the computer system in response to the verification in step 430 being successful. Otherwise, the computer system denies the user access. In some embodiments, after numerous failed attempts, the computer system may prevent the user from attempting to access the system for a period of time.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A non-transitory computer readable medium having program instructions stored thereon that are executable to cause a computer system to perform operations comprising:
displaying a login screen having an arrangement of input fields, wherein each input field is operable to receive a character of a passcode;
receiving a request from a user to access the computer system, wherein the request includes a first passcode having characters input into a first subset of the input fields;
verifying the first passcode against a second passcode of an authorized user, wherein the verifying includes:
comparing characters of the first passcode with characters of the second passcode; and
determining whether the first subset of input fields matches a second subset of the input fields used by the authorized user to input characters of the second passcode; and
based on the verifying, providing access to the computer system.

2. The computer readable medium of claim 1, wherein the comparing and the determining include:
calculating a first hash value for the first passcode based on the characters of the first passcode and identifiers of the first subset of input fields; and
comparing the first hash value with a second hash value calculated for the second passcode.

3. The computer readable medium of claim 2, wherein the displaying includes arranging the input fields into a two-dimensional grid, and wherein the identifiers of the first subset of input fields are positions of the first subset of input fields within the two-dimensional grid.

4. The computer readable medium of claim 2, wherein calculating the first hash value includes:
creating a string by concatenating characters of the first passcode with the identifiers of the first subset of input fields; and
applying a hash function to the string.

5. The computer readable medium of claim 1, wherein the receiving includes:
concealing content of an input field after a character has been input into the input field.

6. The computer readable medium of claim 1, wherein the operations further comprise:
denying access to the user requesting access to the computer system after a number of failed passcode verifications, wherein a length of time for denying the access is based on the number.

7. The computer readable medium of claim 1, wherein the operations further comprise:
displaying an additional input field that is operable to receive a sequence of characters specifying identification information for a user; and
wherein verifying the passcode includes verifying the identification information.

8. A non-transitory computer readable medium having program instructions stored thereon that are executable to cause a computer system to perform operations comprising:
presenting a display having a plurality of input fields arranged in a grid, wherein the plurality of input fields is operable to receive characters of a password;
storing data for a first password of an authorized user, wherein the data indicates a first set of characters included in the first password and indicates a first set of positions for input fields within the grid that are used to input the first set of characters;
receiving a second password of a user that requests access to the computer system, wherein the second password includes a second set of characters input into input fields having a second set of positions within the grid;
determining 1) whether the second set of positions corresponds to the first set of positions and 2) whether the second set of characters matches the first set of characters; and
based on the determining, granting access to functionality of the computer system.

9. The computer readable medium of claim 8, wherein the operations further comprise:
calculate a first hash value by applying a hash function to the first set of characters and values identifying the first set of positions, wherein the stored data includes the first hash value; and
calculating a second hash value by applying the hash function to the second set of characters and values identifying the second set of positions; and
wherein the determining includes comparing the first hash value with the second hash value.

10. The computer readable medium of claim 9, wherein the plurality of input fields are arranged into a plurality of columns and a plurality of rows within the grid, wherein the values identifying the first set of positions include a value identifying a row including an input field in the grid and a value identifying a column including the input field in the grid.

11. The computer readable medium of claim 8, wherein the operations further comprise:
receiving a third password of a user that requests access to the computer system, wherein the third password includes a third set of characters input into input fields having a third set of positions within the grid; and
rejecting access to the computer system in response to determining that the third set of inputs fields differs from the first set of input fields.

12. The computer readable medium of claim 8, wherein the operations further comprise:
rejecting access to the computer system in response to a number of failed attempts of a user satisfying a threshold amount.

13. The computer readable medium of claim 8, wherein the operations further comprise:
hiding characters entered into the plurality of input fields, by replacing the entered characters with a default character indicating that the entered characters are hidden.

14. The computer readable medium of claim 8, wherein the plurality of input fields is arranged into a rectangular grid.

15. The computer readable medium of claim 8, wherein the plurality of input fields is arranged into a triangular grid.

16. A non-transitory computer readable medium having program instructions stored thereon that are executable to cause a computer system to perform operations comprising:
storing information about a first password provided by an authorized entity, wherein the information includes information about characters included in the first password and information identifying a first set of locations where the characters were entered into an arrangement of input fields;
retrieving an access request specifying a second password entered into a second set of locations in the arrangement of input fields;
comparing the first password with the second password, wherein the comparing includes:
determining whether characters of the first password match characters of the second password; and
determining whether the second set of locations matches the first set of locations; and
based on the comparing, determining whether to grant the access request.

17. The computer readable medium of claim 16, wherein the operations further comprise:
determining to not grant the access request in response to determining that the second set of locations does not match the first set of locations, and wherein the first set of locations correspond to a subset of input fields within the arrangement of input fields.

18. The computer readable medium of claim 16, wherein the access request is a request for accessing a computing device.

19. The computer readable medium of claim 16, wherein the retrieving includes:
retrieving the access request over a computer network from a computing device external to the computer system.

20. The computer readable medium of claim 16, wherein the arrangement of input fields has two or more dimensions.
